(19) United States
(12) Patent Application Publication
(10) Pub. No.: US 2005/0082942 A1
(43) Pub. Date: Apr. 21, 2005

(54) Combined power source

(75) Inventor: Paul S. Shirley, Albuquerque, NM (US)

Correspondence Address: PATENT LAW OFFICE OF DAVID G. BECK, P. O. BOX 1146, MILL VALLEY, CA, 94942, US

(73) Assignee: Qynergy Corporation, Albuquerque, NM (US)

(21) Appl. No.: 10/687,030

(22) Filed: Oct. 16, 2003

(51) Int. Cl. G21H 1/00

(52) U.S. Cl. 310/303

(57) ABSTRACT

A means of supplying power to a chip, device or system is provided. The provided power source includes at least one non-radioactive power source that is preferably capable of supplying high current levels for at least short periods of time. The at least one non-radioactive power source is electrically coupled to at least one radioactive power source, the at least one radioactive power source supplying sufficient power to maintain the desired charge in the non-radioactive power source. In combination, the two power sources offer long life and the ability to respond to short duration, high power demands.

### FIELD OF THE INVENTION

The present invention relates generally to batteries and, more particularly, to a battery that combines multiple power sources.

### BACKGROUND OF THE INVENTION

Radioactive power sources, studied since the 1950's, offer advantages in both size and life expectancy. These sources use a radiation source and a suitable semiconductor junction to generate electricity through the direct, solid-state conversion of nuclear energy. Power sources that are based on these techniques are commonly called nuclear batteries, radioisotope batteries, radioactive batteries, or, in the case of using a beta emitting radioisotope, beta cells.

In order to achieve the desired device miniaturization required by many applications, radiation power sources have been fabricated onto a single, common substrate with one or more semiconductor devices. For example, U.S. Pat. No. 2,998,550 discloses a device in which a plurality of semiconductor-based devices (e.g., transistors, diodes) and a radioactive power supply are combined on a single semiconductor substrate. The disclosed device geometry provides electrical isolation of each of the semiconductor-based devices from adjacent devices. One such disclosed geometry provides a plurality of radial tooth-shaped members surrounding a central region wherein each of the tooth-shaped members is used for an individual semiconductor-based device while the radioactive power source is fabricated at the substrate's center.

U.S. Pat. No. 5,642,014 discloses a self-powered semiconductor device in which a radioactive power source and an IC are formed on a substrate, the substrate preferably of p-type material. The radioactive emitter is either fabricated directly into the power source's junction, for example by diffusing tritium atoms into a metal layer formed on the junction, or placed in immediate proximity to the source's junction. The use of a separate metal tritide layer provides some control over the radioactive exposure of the manufacturing environment.

Co-pending U.S. patent application Ser. No. ______, entitled IC Package with an Integrated Power Source, filed Oct. 14, 2003 (attorney docket number 2024438-7005092001) discloses an alternate approach of utilizing a radioactive power source with a semiconductor device. As disclosed, a radioactive power source is resident within an IC package, for example through attachment to the packaging substrate or to another portion of the package such as the package lid. The power source is a stand-alone device, fabricated separately from the IC or other device that is eventually attached to the package. The source can be directly coupled to the mounted IC, for example via package leads/interconnects, or coupled to package pins.

Although radioactive power sources can be used with a variety of devices, they are ideally suited to applications that require a continuous and relatively low current level for an extended period of time (e.g., a cardiac pacemaker). Applications requiring higher current levels or sporadic power typically are better matched to other types of batteries. Accordingly, what is needed in the art is a power source that offers the advantages of both radiation batteries and conventional batteries. The present invention provides such a power source.

### SUMMARY OF THE INVENTION

The present invention provides a means of supplying power to a chip, device or system. The provided power source includes at least one non-radioactive power source that is preferably capable of supplying high current levels for at least short periods of time. The at least one non-radioactive power source is electrically coupled to at least one radioactive power source, the at least one radioactive power source supplying sufficient power to maintain the desired charge in the non-radioactive power source. In combination, the two power sources offer long life and the ability to respond to high power demands.

In one aspect of the invention, the combined power source is contained within a single self-contained package. Preferably the radioactive and non-radioactive power sources are separately contained, thus providing increased manufacturing flexibility while limiting radiation exposure of both personnel and facilities. Typically the radioactive source is shielded from the other source as well as electronic circuitry, thus minimizing potential material damage in near-by components.

In another aspect of the invention, one or more power conditioning circuits are included. The power conditioning circuits prevent over-charging of the non-radioactive source as well as controlling the voltage and current of the source(s). If the sources share a common load, the power conditioning circuit(s) may include a power management circuit in order to distribute the demand according to the respective capacity and power capabilities of the sources.

In another aspect of the invention, the combined power source is coupled to the mounting substrate of an IC package. If desirable, the radioactive power source and the IC can be fabricated together on a single substrate. The combined power source can be electrically coupled to the IC, an external device, or both.

A further understanding of the nature and advantages of the present invention may be realized by reference to the remaining portions of the specification and the drawings.

### BRIEF DESCRIPTION OF THE DRAWINGS

FIG. 1 provides a schematic overview of the present invention;

FIG. 2 provides an overview of an embodiment that includes a power conditioning circuit between the radioactive power source and the non-radioactive power source;

FIG. 3 provides an overview of an embodiment that includes a power conditioning circuit between the non-radioactive power source and the external device to which the combined source is attached;

FIG. 4 is an illustration of a preferred embodiment of the invention;

FIG. 5 is an illustration of an embodiment in which a combined power source is combined with an IC on a plug-in card; and

FIG. 6 is a cross-sectional view of a dual in-line package with an on-board combined power source.

### DESCRIPTION OF THE SPECIFIC EMBODIMENTS

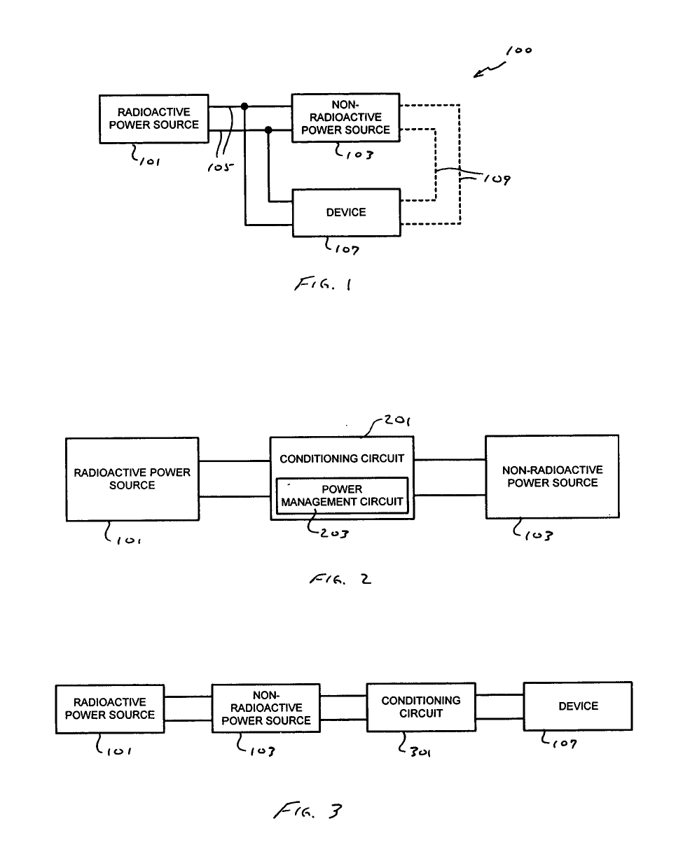

FIG. 1 provides an overview of the present invention. As illustrated, a power source 100 is comprised of at least one radioactive power source 101 coupled to at least one non-radioactive power source 103 via leads 105. Power source 100 can be coupled to a device 107 via leads 105, as shown, thus allowing the load created by device 107 to be shared by sources 101 and 103. Alternately, the power to device 107 can be provided via separate leads 109 (shown in phantom).

FIG. 2 provides an overview of an embodiment of the invention which includes a power conditioning circuit 201 between the at least one radioactive power source 101 and the at least one non-radioactive power source 103. Power conditioning circuit 201 can be used to insure that the at least one non-radioactive power source 103 does not become over-charged, receives the proper voltage and current, receives properly filtered power from source 101, etc. Power conditioning circuit 201 can also provide protection to the at least one radioactive power source 101, for example by preventing potentially damaging power surges. In at least one embodiment of the invention, for example when a common load is shared between the sources as shown in FIG. 1, preferably circuit 201 also includes a power management system 203 which distributes the demand placed on the sources according to their respective capacity and power capabilities.

FIG. 3 provides an overview of an embodiment of the invention which includes a power conditioning circuit 301 between the at least one non-radioactive power source 103 and device 107. Circuit 301 is used to insure that the output of the combined power source is properly filtered, of the required voltage, etc. It will be appreciated that a combined power source of the present invention can include either circuit 201 or circuit 301, both circuits, or neither circuit.

In accordance with the invention, radioactive power source 101 is comprised of at least one junction of two materials having different electrochemical potentials, the at least one junction capable of generating current in response to radiation bombardment. Suitable junctions include homo-junctions, hetero-junctions, and various other semiconductor structures (e.g., metal-oxide-semiconductor structures). Power source 101 is also comprised of at least one radioactive source emitting the necessary alpha, gamma or beta particles. As the radioactive particles pass through the semiconductor material, electrons are excited, thereby creating electron-hole pairs. The local electric field at the semiconductor junction separates the paired electrons and holes to produce an electric current. In a preferred embodiment of the invention, the radioactive power source is a beta cell. Although conventional semiconductor materials can be used such as Si, Ge, GaAs or CdTe, preferably power source 101 uses icosahedral boride semiconductors which are resistant to long-term conventional radiation-induced damage. Icosahedral boride based beta cells suitable for use with the present invention are disclosed in U.S. Pat. No. 6,479,919, the disclosure of which is incorporated herein for any and all purposes.

In accordance with the invention, non-radioactive power source 103 is comprised of a battery, a capacitor or other energy storage medium. In at least one embodiment, non-radioactive power source 103 is a battery selected from zinc-carbon batteries, zinc-chloride batteries, magnesium batteries, aluminum batteries, alkaline-manganese dioxide batteries, mercuric oxide batteries, silver oxide batteries, zinc-air batteries, lithium batteries and solid-electrolyte batteries. Examples of lithium batteries include, but are not limited to, combinations of lithium with sulfur dioxide (SO₂), thionyl chloride (SOCl₂), oxychloride, manganese dioxide (MnO₂), carbon monofluroide (CF), iron disulfide (FeS₂), copper oxide (CuO), copper oxyphosphate (Cu₄O(PO₄)₂) and silver vanadium oxide. Examples of solid-electrolyte batteries include, but are not limited to, Li/LiI(Al₂O₃)/metal salt batteries, lithium/iodine batteries and Ag/RbAg₄I₅/MeNInC batteries.

In at least one alternate embodiment, non-radioactive power source 103 is a battery selected from magnesium water-activated batteries, zinc/silver oxide batteries and thermal batteries (e.g., Ca/CaCrO₄ cells).

In at least one other alternate embodiment, non-radioactive power source 103 is a battery selected from lead-acid batteries, iron electrode batteries (e.g., iron-air batteries, nickel-iron batteries, and silver-iron batteries), nickel-cadmium batteries, nickel-metal hydride batteries, nickel-zinc batteries, nickel-hydrogen batteries, silver oxide batteries, rechargeable lithium and lithium-ion batteries, rechargeable zinc/alkaline/manganese dioxide batteries, metal-air batteries, zinc/bromine batteries, sodium-beta batteries and lithium/iron sulfide batteries.

In at least one other alternate embodiment, non-radioactive power source 103 is a capacitor selected from metal-oxide-semiconductor (MOS) capacitors (e.g., aluminum-silicon dioxide-silicon or aluminum-gallium sulfide-gallium arsenide capacitors), metal-dielectric-metal capacitors, and semiconductor-dielectric-semiconductor capacitors.

In at least one other alternate embodiment, non-radioactive power source 103 is a fuel cell. For example, water could be separated with the electrical power from radioactive power source 101 into hydrogen and oxygen, common fuel cell fuels. Examples of fuel cells that could be used with the invention include, but are not limited to, hydrogen-oxygen (H₂/O₂) fuel cells, metal hydride fuel cells, chemical hydride fuel cells using fuels like LiH+H₂O and NaBH₄+H₂O, carbon-based H₂ storage like carbon nanofibers, and methanol fuel cells like methanol-water and MeOH fuel cells.

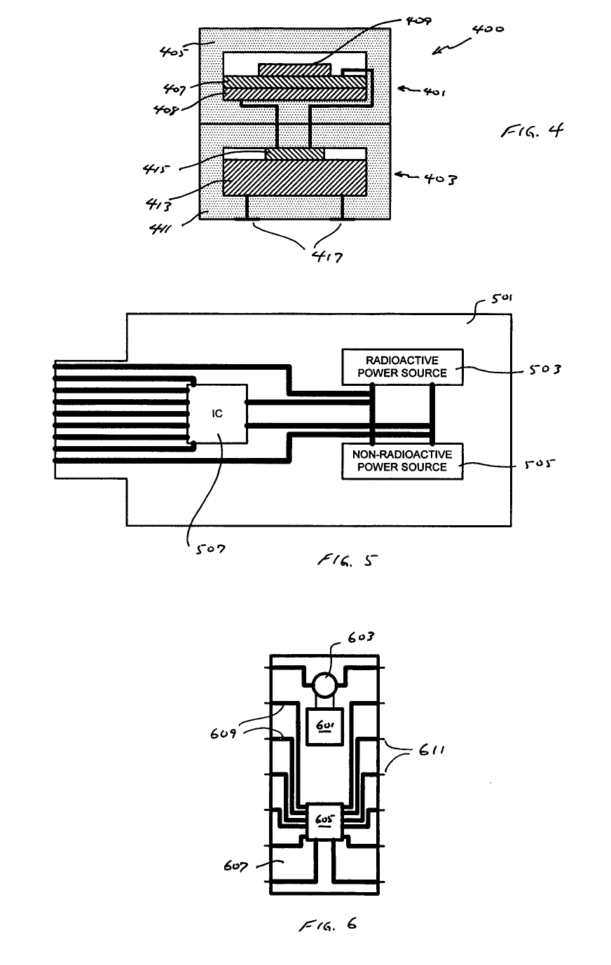

FIG. 4 is an illustration of a preferred embodiment of the invention comprised of two portions, radioactive power source portion 401 and non-radioactive power source portion 403, coupled together to form a single power source 400. By using two separate portions, the radioactive power source portion 401 can be manufactured in a different facility or a segregated portion of the same facility from the remainder of the source, thus minimizing radiation exposure of both personnel and facilities while maximizing fabrication flexibility. Additionally, separating fabrication steps insures that associated circuitry (e.g., conditioning circuitry) is neither damaged nor contaminated through radiation exposure.

Radioactive power source portion 401 is comprised of a container 405, which acts as a radioactive shield, one or more semiconductor junctions 407/408 and a suitable radioactive particle emitter 409. Non-radioactive power source portion 403 is comprised of a container 411, a battery 413 (e.g., battery, capacitor or fuel cell) and preferably conditioning circuitry 415. A pair of electrodes 417 is used to electrically couple the source to the desired load (e.g., an application or device, not shown). Preferably one or both containers 405 and 411 are openable and resealable, thus allowing components within the containers to be replaced and/or repaired as necessary.

It will be appreciated that the combined power source of the present invention can be used in countless applications. For example, a source in accordance with the invention can be combined with other devices such as integrated circuits (ICs) to form a self-powered device. The radioactive power source can either be separate from the IC or fabricated on the same substrate. If desired, such a combination can be used to power external devices. FIG. 5 illustrates one such embodiment in which a plug-in card 501 includes a radioactive power source 503, a non-radioactive power source 505 and at least one IC 507. Thus, for example, if card 501 was used with a hand-held gaming device, it could include game software as well as sufficient power to operate the gaming device.

Another application of the combined power source of the present invention is in an IC package. For example, FIG. 6 is a cross-sectional view of a dual in-line package (i.e., DIP) according to the invention. As shown, a radioactive power source 601 is coupled to a non-radioactive power source 603. An IC 605 is also attached to the package mounting substrate 607. A plurality of wire connects 609 couple IC 605 and the combined power source to corresponding pins 611. After completion of the wiring, a top portion (not shown) of the package is attached to bottom mounting substrate 607. The top and bottom portions may be hermetically sealed together. Although the power source is not shown coupled to IC 605, it will be appreciated that the inventor also anticipates electrically coupling the source to the package's on-board IC. Additionally, the present invention is not limited to inclusion in a DIP package. For example, the disclosed combined power source can be used with plastic quad flat pack (PQFP) packages, single in-line packages (SIPs), ceramic flatpacks, pin grid array (PIN) packages, small outline IC (SOIC) packages, quarter size small outline packages (QSOPs), leadless chip carriers (LCCs), plastic leaded chip carriers (PLCCs), multi-chip modules (MCMs) or any other type of package.

As will be understood by those familiar with the art, the present invention may be embodied in other specific forms without departing from the spirit or essential characteristics thereof. Accordingly, the disclosures and descriptions herein are intended to be illustrative, but not limiting, of the scope of the invention which is set forth in the following claims.

1. A power source comprising:
at least one non-radioactive power source; and
at least one radioactive power source in electrical communication with said at least one non-radioactive power source, said at least one radioactive power source comprising:
at least one junction of a first material and a second material, wherein said first material has a first electrochemical potential and said second material has a second electrochemical potential, wherein said first and second electrochemical potentials are different; and
at least one radiation source.

2. The power source of claim 1, wherein said at least one radioactive power source maintains a charge associated with said at least one non-radioactive power source.

3. The power source of claim 1, further comprising a power conditioning circuit interposed between and in electrical communication with said at least one non-radioactive power source and said at least one radioactive power source.

4. The power source of claim 3, said power conditioning circuit further comprising a power management circuit.

5. The power source of claim 1, further comprising a pair of power source outputs and a power conditioning circuit, said power conditioning circuit interposed between and in electrical communication with said at least one non-radioactive power source and said pair of power source outputs.

6. The power source of claim 1, wherein said at least one junction is selected from the group consisting of homo-junctions and hetero-junctions.

7. The power source of claim 1, wherein said at least one junction is a metal-oxide-semiconductor structure.

8. The power source of claim 1, wherein said at least one radioactive power source is a beta cell.

9. The power source of claim 8, wherein said beta cell is comprised of an icosahedral boride semiconductor.

10. The power source of claim 1, wherein said at least one non-radioactive power source is selected from the group consisting of zinc-carbon batteries, zinc-chloride batteries, magnesium batteries, aluminum batteries, alkaline-manganese dioxide batteries, mercuric oxide batteries, silver oxide batteries, zinc-air batteries, lithium batteries, solid-electrolyte batteries, magnesium water-activated batteries, zinc/silver oxide batteries, thermal batteries, lead-acid batteries, iron electrode batteries, nickel-cadmium batteries, nickel-metal hydride batteries, nickel-zinc batteries, nickel-hydrogen batteries, silver oxide batteries, rechargeable lithium and lithium-ion batteries, rechargeable zinc/alkaline/manganese dioxide batteries, metal-air batteries, zinc/bromine batteries, sodium-beta batteries and lithium/iron sulfide batteries.

11. The power source of claim 1, wherein said at least one non-radioactive power source is a capacitor selected from the group consisting of metal-oxide-semiconductor (MOS) capacitors, metal-dielectric-metal capacitors, and semiconductor-dielectric-semiconductor capacitors.

12. The power source of claim 1, wherein said at least one non-radioactive power source is a fuel cell.

13. The power source of claim 12, wherein said fuel cell is selected from the group consisting of hydrogen-oxygen fuel cells, metal hydride fuel cells, chemical hydride fuel cells, and methanol fuel cells.

14. A semiconductor package comprising:
a package substrate;
a plurality of pins attached to said substrate;
a plurality of package leads in electrical communication with said plurality of pins;
at least one non-radioactive power source mounted to said semiconductor package; and
at least one radioactive power source mounted to said semiconductor package and in electrical communication with said at least one non-radioactive power source, said at least one radioactive power source comprising:
at least one junction of a first material and a second material, wherein said first material has a first electrochemical potential and said second material has a second electrochemical potential, wherein said first and second electrochemical potentials are different; and
at least one radiation source.

15. The semiconductor package of claim 14, further comprising an IC mounted to said package substrate and in electrical communication with said plurality of package leads.

16. The semiconductor package of claim 14, further comprising a power conditioning circuit interposed between and in electrical communication with said at least one non-radioactive power source and said at least one radioactive power source.

17. The semiconductor package of claim 16, said power conditioning circuit further comprising a power management circuit.

18. The semiconductor package of claim 14, further comprising a pair of power source outputs and a power conditioning circuit, said power conditioning circuit interposed between and in electrical communication with said at least one non-radioactive power source and said pair of power source outputs.

19. The semiconductor package of claim 14, wherein said at least one radioactive power source is a beta cell.

20. The semiconductor package of claim 19, wherein said beta cell is comprised of an icosahedral boride semiconductor.

21. The semiconductor package of claim 14, wherein said at least one non-radioactive power source is selected from the group consisting of zinc-carbon batteries, zinc-chloride batteries, magnesium batteries, aluminum batteries, alkaline-manganese dioxide batteries, mercuric oxide batteries, silver oxide batteries, zinc-air batteries, lithium batteries, solid-electrolyte batteries, magnesium water-activated batteries, zinc/silver oxide batteries, thermal batteries, lead-acid batteries, iron electrode batteries, nickel-cadmium batteries, nickel-metal hydride batteries, nickel-zinc batteries, nickel-hydrogen batteries, silver oxide batteries, rechargeable lithium and lithium-ion batteries, rechargeable zinc/alkaline/manganese dioxide batteries, metal-air batteries, zinc/bromine batteries, sodium-beta batteries and lithium/iron sulfide batteries.

22. The semiconductor package of claim 14, wherein said at least one non-radioactive power source is a capacitor selected from the group consisting of metal-oxide-semiconductor (MOS) capacitors, metal-dielectric-metal capacitors, and semiconductor-dielectric-semiconductor capacitors.

23. The semiconductor package of claim 14, wherein said at least one non-radioactive power source is a fuel cell.

24. The semiconductor package of claim 23, wherein said fuel cell is selected from the group consisting of hydrogen-oxygen fuel cells, metal hydride fuel cells, chemical hydride fuel cells, and methanol fuel cells.

25. The semiconductor package of claim 14, wherein said semiconductor package is selected from the group consisting of DIPs, PQFPs, SIPs, ceramic flatpacks, PIN packages, SOIC packages, QSOPs, LCC packages, and PLCCs.

26. The semiconductor package of claim 15, further comprising a substrate, wherein said IC and said at least one radiation power source are each fabricated on said substrate.

27. The semiconductor package of claim 14, further comprising a radiation shield substantially containing said at least one radiation power source.
